(19) United States
(12) Patent Application Publication
(10) Pub. No.: US 2010/0210748 A1
(43) Pub. Date: Aug. 19, 2010

(54) REACTIVE POLYURETHANE COMPOSITIONS

(75) Inventors: Marc Leimenstoll, Hilden (DE); Christos Karafilidis, Leverkusen (DE); Matthias Wintermantel, Bergisch Gladbach (DE); Peter Reichert, Dormagen (DE); Lutz Brassat, Leverkusen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/688,394

(22) Filed: Jan. 15, 2010

(30) Foreign Application Priority Data
Jan. 17, 2009 (DE) 102009005017.5

(51) Int. Cl. C08J 9/00; C08G 18/06; C08L 75/04

(52) U.S. Cl. 521/159; 525/457; 528/59; 524/590

(57) ABSTRACT

The present invention relates to reactive polyurethane compositions having only small amounts of free, low molecular weight diisocyanates before and after crosslinking, and to the production thereof and the use thereof in reactive one- and two-component adhesives/sealants, bonding foams, encapsulating compounds and in flexible, rigid and integral foams.

### RELATED APPLICATIONS

This application claims benefit to German Patent Application No. 10 2009 005 017.5, filed Jan. 17, 2009, which is incorporated herein by reference in its entirety for all useful purposes.

### BACKGROUND OF THE INVENTION

The present invention relates to reactive polyurethane compositions having only small amounts of free, low molecular weight diisocyanates before and after crosslinking, and to the production thereof and the use thereof in reactive one- and two-component adhesives/sealants, bonding foams, encapsulating compounds and in flexible, rigid and integral foams.

Reactive polyurethanes have NCO end groups which can react with water or other compounds having an acidic hydrogen atom. This form of reactivity makes it possible to bring the reactive polyurethanes to the desired location in a processable state, e.g. liquid to highly viscous, and to cure them by adding water or other compounds having an acidic hydrogen atom.

Reactive polyurethanes can be used in many technical areas. One important area of application for polyurethanes is e.g. one-component foams from aerosol containers, also referred to as aerosol foams or bonding foams, as well as adhesives and sealants.

In these areas of application, mostly mixtures of diphenylmethane diisocyanate (MDI) and/or polyphenylene polymethylene polyisocyanates, often also referred to as crude MDI or polymeric MDI, and/or reaction products of polyisocyanates with a substoichiometric quantity of compounds having at least two hydrogen atoms that are reactive with isocyanate groups, so-called NCO prepolymers, are mainly used as the polyisocyanates.

In reactive polyurethanes for use in aerosol foams, polymeric MDI is mainly used as the polyisocyanate. This generally contains a large proportion of 2-ring MDI.

Aerosol foams are frequently used assembly agents in the construction sector for the installation of windows and doors in buildings and as a filler material for cavities created by construction technology or wall ducts for pipe installations. An aerosol container of this type contains a prepolymer as well as blowing agent and additives. By discharging its contents by means of blowing agent, foaming them by evaporation of the blowing agent (so-called froth effect) and curing with atmospheric humidity, the desired foam is obtained.

One-component foams based on NCO-containing prepolymers are the best known foams of this type. Various of these products exist, which lead to rigid to soft elastic foams, depending on their composition.

Reactive polyurethane compositions generally still contain, as a result of their production, low molecular weight, monomeric isocyanates. These have the disadvantage that they can cause health risks. Thus, during transition of the compositions to the vapour phase or as an aerosol, it must be ensured that people cannot come into contact with those vapours which contain low molecular weight monomeric isocyanates. Furthermore, skin contact with these reactive polyurethane compositions should be avoided as far as possible.

Since protective and cleaning measures are usually associated with great technical complexity, high financial investments or costs, the need arises on the part of the user for products having the lowest possible proportion of monomeric diisocyanates. However, it is not only the use of reactive polyurethane compositions that still contain monomeric diisocyanates which leads to problems, but even the marketing of these compositions. Thus, substances and preparations which contain, for example, more than 0.1 wt. % free MDI or TDI are covered by the Gefahrstoffverordnung (German Dangerous Substances Ordinance) and must be labelled accordingly. Associated with the compulsory labelling are special measures relating to packaging and transport. The presence of monomeric, unreacted diisocyanate also leads to frequent problems in further processing. For example, these diisocyanates can migrate out of the coating or bonded joint into the coated or bonded materials.

Furthermore, not only are the monomeric, low molecular weight isocyanates harmful to health but the resulting reaction products with water, e.g. aromatic diamines or polyamines, also present a health risk. By contact with humidity, isocyanate groups are continuously converted to amino groups and other secondary products. These compounds can occur not only directly during the curing of the polyurethane systems. As a result of the slowing rate of reaction, it is also possible that these may occur in the long term under the conditions of use, such as e.g. at higher temperatures and with high atmospheric humidity. These amino compounds can also migrate to the surface or into surrounding layers. These migrating components based on low molecular weight, aromatic di- or polyamines are referred to hereinafter as migrates.

In polyurethane integral foams, which are used e.g. in the production of steering wheels in motor vehicles, these migrates are undesirable since contact of the amines formed from the diisocyanates with the skin cannot be ruled out. In the packaging sector too, and especially in foodstuffs packaging, migrates are undesirable. The migration of the migrates through the packaging material can lead to contamination of the packaged product or skin contact with the packaging can transfer these migrates.

According to WO 2001/0 040 342, PU compositions with a low content of monomeric diisocyanates can be produced in a two-step process. The unreacted monomeric diisocyanate is removed from a first reaction product and the product obtained is further reacted to form a prepolymer with a higher molecular weight. This prepolymer is suitable for use as a binder for reactive one- or two-component adhesives/sealants or reactive hot melt adhesives.

In EP-A 1 237 971, which belongs to the same patent family, PU compositions with a low content of isocyanate monomers are described, wherein the monomeric diisocyanates are reduced to a content of less than 10 wt. %, e.g. by precipitating them out as insoluble compounds. In particular, the use of asymmetrical diisocyanates in these PU compounds is described.

EP-A 0 316 738 describes a process for the production of polyisocyanates containing urethane groups, having a starting diisocyanate content of no more than 0.4 wt. % by reacting aromatic diisocyanates with polyhydric alcohols and subsequently removing the unreacted excess starting diisocyanate by distillation.

In DE-A 10 2004 038 784, a process is described for the production of low monomer content polyisocyanates by the removal by distillation of monomeric isocyanate from polyisocyanates, polyisocyanate prepolymers and/or polyisocyanate derivatives containing monomeric isocyanate. The solution described there provides that reactive polyisocyanates are freed of monomeric isocyanates by using falling-film short-path evaporators. In particular, the residual monomer content in the polyisocyanates or prepolymers treated in this way should be less than 0.1 wt. % based on the polyisocyanate. However, the teaching does not describe any low monomer content prepolymers based on exclusively aromatic polymeric isocyanates with an average functionality of more than 2, having at least two NCO groups and with a content of <5 wt. % of unreacted monomeric isocyanates.

According to the teaching of EP-A 1 518 874, it is known that a low monomer content isocyanate is used to prepare one-component foams which is obtained from a defined polyphenylene polymethylene polyisocyanate by removal of the monomeric isocyanate by distillation. By using this product, optionally in a mixture with diluents and other compounds containing isocyanate groups, low monomer content one-component foams are obtained in this way. It is a disadvantage here that one-component aerosol foams produced in this way have low storage stability and therefore the contents of the pressurised aerosol containers become solid and thus unusable within a few weeks.

WO2005/0 007 721 also describes the use of mixtures of low monomer content, NCO-terminal prepolymers, i.e. reaction products of polyols and diphenylmethane diisocyanate in a stoichiometric excess, freed of monomers, demonomerised polyphenylene polymethylene polyisocyanate, trimerised hexamethylene diisocyanate and diluents. Disadvantages here are the extremely high viscosities of the feed materials to achieve the reduced monomer content required, which creates technological difficulties in their use, and the fact that their storage stability is not guaranteed, as in the solution according to EP-A 1 518 874.

In EP-B 1 451 239, a process is described for the production of low monomer content prepolymers by the reaction of monomeric 2,4′-diphenylmethane diisocyanate or mixtures of 2,4′-diphenylmethane diisocyanate and 4,4′-diphenylmethane diisocyanate or mixtures of 2,4′-, 2,2′- and 4,4′-diphenylmethane diisocyanate and polyphenyl polymethylene polyisocyanates with a substoichiometric quantity of a polyether alcohol and subsequent distillation of the reaction product by means of a short-path evaporator. The products obtained are said to be distinguished from low monomer content prepolymers based on monomeric 4,4′-MDI by significantly lower viscosities. However, the teaching does not describe the viscosities of low monomer content prepolymers based on exclusively aromatic polymeric isocyanates with an average functionality of more than 2.

In EP-A 1 964 868, crosslinking 1-component or 2-component PU compositions are described, which contain reaction products of polyols and aromatic diisocyanates, wherein the composition contains less than 0.1 wt. % unreacted monomeric aromatic isocyanates. A disadvantage of these compositions is their extremely high viscosity, particularly if polyols with functionalities greater than 2 are used.

Despite the aforementioned prior art relating to the reduction of the monomeric diisocyanates, there is still a need for reactive polyurethane compositions which have only very small amounts of free low molecular weight diisocyanates before and after crosslinking, and have high functionalities and low viscosities. The reactive compositions should be suitable both for use as one- and two-component adhesives/sealants, particularly as hot melt adhesives or laminating adhesives, and for the production of encapsulating compounds, bonding foams and flexible, rigid and integral foams, and therefore the object existed of providing these.

### EMBODIMENTS OF THE INVENTION

An embodiment of the present invention is a crosslinking 1-component or 2-component polyurethane composition comprising an NCO-terminated polyurethane prepolymer, wherein said NCO-terminated polyurethane prepolymer is (1) the reaction product of a polyol and an aromatic polymeric isocyanate having an average functionality of greater than 2, (2) contains at least two NCO groups, and (3) has a content of unreacted monomeric isocyanates of less than 5 weight %.

Another embodiment of the present invention is the above composition, wherein said prepolymer has a content of unreacted monomeric aromatic isocyanates of less than 3 weight %.

Another embodiment of the present invention is the above composition, wherein said prepolymer has a content of unreacted monomeric aromatic isocyanates of less than 1 weight %.

Another embodiment of the present invention is the above composition, wherein said prepolymer has a content of unreacted monomeric aromatic isocyanates of less than 0.2 weight %.

Another embodiment of the present invention is the above composition, wherein said aromatic polymeric isocyanate comprises a proportion of a monomeric isocyanate of at least 10 weight %.

Another embodiment of the present invention is the above composition, wherein said prepolymer further comprises a low monomer content polymeric aromatic isocyanate having a functionality of greater than 2.

Yet another embodiment of the present invention is a reactive polyurethane prepolymer prepared from the above composition.

Yet another embodiment of the present invention is a crosslinking component in a crosslinkable 1-component or 2-component polyurethane composition, wherein said crosslinking component comprises the above composition.

Yet another embodiment of the present invention is a reactive 1-component or 2-component adhesive or sealant comprising the above composition.

Yet another embodiment of the present invention is a laminating adhesive or hot-melt adhesive comprising the above composition.

Yet another embodiment of the present invention is a bonding, flexible, rigid, or integral foam comprising the above composition.

Yet another embodiment of the present invention is a moisture-curing plastic moulding composition or encapsulating compound comprising the above composition.

### DESCRIPTION OF THE INVENTION

The achievement of this object according to the invention can be taken from the claims. The present invention provides crosslinkable 1-component or 2-component polyurethane compositions, which contain at least one NCO-terminated polyurethane prepolymer, characterised in that the NCO-terminated polyurethane prepolymer is a reaction product of polyols and aromatic polymeric isocyanates with an average functionality of more than 2, it contains at least two NCO groups and it has a content of unreacted monomeric isocyanates of <5 wt. %.

The invention also provides the use of these 1-component or 2-component PU compositions as or in adhesives or sealants. The invention also provides the use of these compositions as a reactive encapsulating compound or as a curable plastic material. The invention also provides the use of these compositions as a foaming material. The present invention also provides shaped articles produced from polyurethane compositions according to the invention by shaping and subsequent crosslinking.

The PU compositions that are suitable according to the invention are produced starting from reactive NCO-terminated polyurethane prepolymers. The process and method for producing these reactive NCO-terminated polyurethane prepolymers are known to the person skilled in the art. These NCO-terminated polyurethane prepolymers, at least some of which must be contained in the PU compositions according to the invention, are reaction products of polymeric polyisocyanates and polyols. To carry out the reaction, an NCO/OH ratio of more than 1 is selected, as a result of which NCO-reactive products are obtained.

The conventional polyol compounds known to the person skilled in the art are to be used as polyols. Within the framework of the invention, a wide variety of polyfunctional alcohols may be used. These should have 2 to 10, particularly from 2 to 4 OH groups per molecule. They can be low molecular weight compounds or OH-functional polymers. However, it is necessary that these compounds do not contain any other functional groups that are reactive with NCO groups. The compounds with multiple OH groups can be those that have exclusively terminal OH groups, or they can be compounds that (also) have lateral OH groups distributed along the chain. The OH groups in question are, in any case, those which can react with isocyanates. They can be primary, secondary or tertiary OH groups, but primary or secondary OH groups are preferred. Examples of suitable compounds of this type are polyols based on polyethers, polyesters or polyalkylenes, which can be liquid, amorphous or crystalline.

Aliphatic or araliphatic alcohols with 2-10 OH groups per molecule are suitable, for example. Primary and secondary alcohols can preferably be used. Trifunctional alcohols such as glycerol, trimethylolethane and/or trimethylolpropane or alcohols with higher functionality, such as e.g. pentaerythritol or sugar alcohols, can be used. Hydroxyalkyl-substituted phenols or cycloaliphatic diols or polyols can also be used.

The suitable aliphatic alcohols include, for example, ethylene glycol, propylene glycol, 1,4-butanediol, 1,5-pentanediol, 1,6-hexanediol, 1,7-heptanediol, 1,8-octanediol 1,10-decanediol, 1,12-dodecanediol, dimer fatty alcohol and their higher homologues or isomers. Alcohols of higher functionality are also suitable, such as e.g. glycerol, trimethylolpropane, pentaerythritol or their homologues. Suitable aliphatic alcohols have a molecular weight of 60 to 600 g/mol, particularly up to about 400 g/mol. In particular, however, linear alcohols with 2 to 30 C atoms having two to four OH groups are used.

Also suitable as the polyol component are reaction products of low molecular weight polyfunctional alcohols with alkylene oxides, so-called polyethers. The alkylene oxides preferably have 2 to 4 C atoms. Suitable examples are the reaction products of ethylene glycol, propylene glycol, the isomeric butanediols, hexanediols or 4,4′-dihydroxydiphenylpropane with ethylene oxide, propylene oxide, butylene oxide or mixtures of two or more thereof. In addition, the reaction products of polyfunctional alcohols, such as glycerol, trimethylolethane or trimethylolpropane, pentaerythritol or sugar alcohols with the above-mentioned alkylene oxides to form polyether polyols are suitable. Other polyols that are suitable within the framework of the invention are formed by polymerisation of tetrahydrofuran (poly-THF). The polyether polyols are known and commercially available.

Particularly suitable are, for example, polyether polyols with a molecular weight of 100-10000 g/mol, preferably 400-6000 g/mol (number-average molecular weight Mₙ, measured by GPC) and particularly polypropylene glycol or polyethylene glycol with 2 to 4 OH groups. Random and/or block copolymers can be used.

In addition, polyester polyols are suitable. Polyester polyols are either liquid at room temperature (glass transition temperature T_{g}<20° C.) or solid. Polyester polyols which are solid at room temperature are either amorphous (glass transition temperature T_{g}>20° C.) or crystallising.

Suitable crystallising polyesters are, for example, those based on linear aliphatic dicarboxylic acids with at least 2 carbon atoms, preferably at least 6 carbon atoms, particularly preferably 6 to 14 carbon atoms in the molecule, such as e.g. adipic acid, azelaic acid, sebacic acid and dodecanedioic acid, preferably adipic acid and dodecanedioic acid and linear diols with at least 2 carbon atoms, preferably at least 4 carbon atoms, particularly preferably 4-6 carbon atoms in the molecule, preferably with an even number of carbon atoms such as e.g. 1,4-butanediol and 1,6-hexanediol. The polycaprolactone derivatives based on bifunctional starter molecules, such as e.g. 1,6-hexanediol, should also be mentioned as particularly suitable.

Suitable amorphous polyester polyols are e.g. those based on adipic acid, isophthalic acid, terephthalic acid, ethylene glycol, neopentyl glycol and 3-hydroxy-2,2-dimethylpropyl-3-hydroxy-2,2-dimethylpropanoate.

Suitable polyester polyols which are liquid at room temperature are, for example, those based on adipic acid, ethylene glycol, 1,6-hexanediol and neopentyl glycol.

However, polyester polyols of oleochemical origin can also be used. These polyester polyols can, for example, be produced by complete ring opening of epoxidised triglycerides of an at least partly olefinically unsaturated fatty-acid-containing fat mixture with one or more alcohols with 1 to 12 C atoms and subsequent partial transesterification of the triglyceride derivatives to form alkyl ester polyols with 1 to 12 C atoms in the alkyl residue. OH-functional polyesters are generally known to the person skilled in the art and are commercially available. Particularly suitable are polyester polyols containing two or three terminal OH groups. Polyester polyols preferably have a molecular weight of about 100 to 6000 g/mol, particularly less than 5000 g/mol.

Another suitable group of polyalcohols are polyurethane polyols. These are reaction products of polyisocyanates, preferably diisocyanates, with polyols, particularly diols. These polyols can be selected from the above-mentioned group of polyols. The quantities are selected such that terminally OH-terminated products are obtained. The functionality of the PU polyols should preferably be between 2 and 4. The molecular weight should be between 100 and 6000 g/mol. These OH-terminated PU polyols are known to the person skilled in the art.

Other suitable polyols are e.g. polycarbonate polyols and dimer diols, as well as castor oil and its derivatives. The hydroxyfunctional polybutadienes, as are available e.g. with the trade name “Poly-bd”, can also be used as polyols for the compositions according to the invention. Also suitable as the polyol component are polyacetals. Polyacetals are e.g. reaction products of glycols, e.g. diethylene glycol or hexanediol, with formaldehyde. Polyacetals can also be obtained by the polymerisation of cyclic acetals. Polycarbonates are also suitable as polyols. Another group of polyols that can be used according to the invention are the polyesters based on ε-caprolactone. These polyols should have at least 2 OH groups in the molecule.

As the isocyanate in the isocyanate reaction products according to the invention, it is possible to use all polymeric polyisocyanates known to the person skilled in the art. These are preferably aromatic isocyanate compounds having two or more NCO groups. Particularly preferred are polyphenylene polydimethylene polyisocyanates containing proportions of monomeric aromatic diisocyanates. These are, for example, the known industrial raw materials “crude MDI” and the “polymeric MDI” obtainable therefrom. The person skilled in the art understands the term crude MDI to mean the crude product obtained during the industrial synthesis of MDI after the phosgenation step, which is a mixture of the known binuclear MDI isomers and polynuclear (≧3) oligomers. This is worked up by distillation in a further step to give so-called polymeric MDI, which is a crude MDI depleted in binuclear MDI isomers and other low-boiling by-products.

It is also possible for proportions of aliphatic or cycloaliphatic isocyanates to be contained.

Monomeric diisocyanates are, for example, selected from the group of diphenylmethane diisocyanate (MDI) with all its isomers [4,4′-diphenylmethane diisocyanate (4,4′-MDI), 2,4′-diphenylmethane diisocyanate (2,4′-MDI), 2,2′-diphenylmethane diisocyanate (2,2′-MDI)], hydrogenated or partially hydrogenated MDI (H12MDI, H6MDI), xylylene diisocyanate (XDI), tetramethylxylylene diisocyanate (TMXDI), di- and tetraalkylene diphenylmethane diisocyanate, 4,4′-dibenzyl diisocyanate, 1,3-phenylene diisocyanate, 1,4-phenylene diisocyanate, the isomers of toluene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, tetramethoxy-butane-1,4-diisocyanate, naphthalene-1,5-diisocyanate (NDI), butane-1,4-diisocyanate, hexane-1,6-diisocyanate (HDI), dicyclohexylmethane diisocyanate, tetramethylene, hexamethylene, undecane, dodecamethylene, 2,2,4-trimethylhexane-2,3,3-trimethylhexamethylene diisocyanate, cyclohexane-1,4-diisocyanate, ethylene diisocyanate, triphenylmethane-4,4′,4″-triisocyanate (MIT), phthalic acid bisisocyanatoethyl ester, diisocyanates with reactive halogen atoms, such as 1-chloromethylphenyl-2,4-diisocyanate, 1-bromomethylphenyl-2,6-diisocyanate, 3,3-bischloromethyl ether-4,4′-diphenyl diisocyanate. Other diisocyanates that can be used are trimethyl hexamethylene diisocyanate, 1,4-diisocyanatobutane, 1,12-diisocyanatododecane and dimer fatty acid diisocyanate, lysine ester diisocyanate, 4,4-dicyclohexylmethane diisocyanate, 1,3-cyclohexane or 1,4-cyclohexane diisocyanate.

Also particularly suitable are monomeric, asymmetrical diisocyanates having NCO groups with different reactivities towards diols. Examples of particularly suitable aromatic diisocyanates with differently reactive NCO groups are the isomers of TDI, NDI, 1,3-phenylene diisocyanate or 2,4′ MDI. At least 50% of the NCO groups of the isocyanate reaction product are based on aromatic isocyanates, particularly more than 90%.

The NCO-terminated polyurethane prepolymers that are suitable according to the invention are produced by known processes from the above-mentioned polyols and polymeric polyisocyanates containing proportions of monomeric diisocyanates. This can take place for example at room temperature, and elevated temperatures can also be used. The starting compounds generally react with one another spontaneously, but it may also be necessary for catalysts, such as organometallic compounds or organic amino compounds, to be added. In addition, the known processes are used to remove the unreacted proportions of monomeric diisocyanates. This can take place e.g. by distillation, precipitation or by trapping the monomeric diisocyanates using low molecular weight reactive components. The process of distillation using a short-path evaporator is preferred.

The NCO-terminated polyurethane prepolymers according to the invention should have a content of monomeric, unreacted aromatic diisocyanates of less than 5 wt. %, preferably less than 3 wt. %, particularly preferably less than 1 wt. %, most particularly preferably less than 0.2 wt. %. The number of NCO groups per molecule is between 1 and 5, preferably 2 to 4, and in particular, exclusively reactive aromatic isocyanate groups are contained. The reaction products contain at least two urethane groups in the molecule.

Depending on the molecular weight and the polyol components selected, these isocyanate reaction products can be in liquid or solid form. It is also possible for the NCO-terminated polyurethane prepolymers to be dissolved in inert organic solvents.

These NCO-terminated polyurethane prepolymers can be used as crosslinking components directly in reactive PU compositions, for example in 1-component or 2-component PU compositions, or they are reacted with suitable compounds in further reaction steps, e.g. with the OH polyols listed above which can react with the NCO groups. These PU prepolymers can then be used, for example, in the above-mentioned PU compositions.

The reactive polyurethane prepolymers according to the invention can be used in reactive one- and two-component adhesives/sealants, bonding foams, encapsulating compounds and in flexible, rigid and integral foams. A substantial advantage over the known reactive polyurethane compositions is the significantly lower proportion of aromatic monomeric diisocyanates which are capable of migration and are harmful from an occupational health point of view.

The PU compositions according to the invention can also contain other additives. These can be, for example, catalysts, resins, solvents, pigments, stabilisers, adhesion promoters, dyes, flow control agents and similar auxiliary substances. The person skilled in the art can select these according to the intended application.

One preferred application of the PU compositions relates to reactive, one-component, moisture-curing hot melt adhesives. These hot melt adhesives can additionally contain tackifying resins, adhesion-promoting additives, fillers, pigments, plasticisers, stabilisers and/or catalysts, waxes or mixtures thereof as well as other conventional auxiliary substances and additives.

Tackifying resins that can be used are e.g. abietic acid, abietic acid ester, terpene resins, terpene phenol resins, phenol-modified styrene polymers, phenol-modified α-methylstyrene polymers or hydrocarbon resins. Suitable as catalysts are the known organometallic and/or amine catalysts in amounts of up to 2%, e.g. the organometallic compounds of tin, iron, titanium or bismuth, such as tin(II) salts of carboxylic acids or the dialkyltin(IV) carboxylates. Examples of antioxidants that can be used are the commercial sterically hindered phenols and/or thio ethers and/or substituted benzotriazoles or the HALS-type sterically hindered amines. In particular, it is also possible to add plasticisers in special compositions. These are preferably plasticisers of the phthalic acid ester type or the naphthenic oils type.

Another embodiment of the invention uses the PU compositions according to the invention as a laminating adhesive. When used as a laminating adhesive, a further addition of epoxy resins, phenolic resins, novolaks, resols or melamine resins and similar polymers may be useful to achieve certain additional properties, such as heat resistance and chemical resistance. In this case, moreover, the reactive PU compositions can also be prepared in solution, preferably in polar, aprotic solvents. The preferred solvents in this case have a boiling range (under standard pressure) of about 50° C. to 140° C.

Another embodiment of the invention uses the PU compositions according to the invention as liquid 1-component or 2-component adhesives or sealants. In the case of 2-component systems, the second binder component can be selected according to the intended application and the properties. It can comprise those compounds that have at least two functional groups which are reactive with NCO groups. Examples of these are OH, SH, COOH, NH and NH₂ groups, preferably polyols. The selection of the polyols in this case depends on the type of use of this adhesive/sealant composition, e.g. hydroxyfunctional polyols based on polyester, polyurethane, polyether or polyolefin. In the case of 1-component adhesives/sealants, the NCO-terminated polyurethane prepolymer is preferably converted to higher molecular weight PU prepolymers or is additionally contained. Moisture-curing systems are then obtained.

The 1-component or 2-component polyurethane compositions that are suitable according to the invention can also be used particularly as a polyurethane foam. This involves mixtures of reactive polyurethanes which either form a foam on application under the curing conditions, e.g. by reaction with atmospheric humidity, or it involves mixtures which contain foam-forming substances. These can be compressed gases which foam under reduced pressure, such as e.g. CO₂, N₂O etc. In self-foaming PU compositions, it is particularly useful if high molecular weight, polymeric polyisocyanates are additionally contained. They should contain no, or less than 0.1 wt. %, monomeric isocyanates.

Polyurethane foams according to the invention can also contain other additives known to the person skilled in the art, such as e.g. adhesion promoters, plasticisers, wetting agents, fillers, flame retardants, foaming agents, fibres, masterbatches or pigments. In particular, they contain catalysts which are suitable for a rapid curing reaction and foaming reaction. These are generally aliphatic tertiary amines, e.g. those which additionally contain groups that are reactive towards isocyanates. Most particularly preferred catalysts, however, are the derivatives of morpholine, such as bis(morpholinopropyl)propylamine, morpholinopropyl pyrrolidone or dimorpholinodiethyl ether (DMDEE) or di-2,6-dimethyl morpholinoethyl ether.

Bonding foams are produced at the site where they are used, therefore they are also referred to as in-situ foam. In particular, these are moisture-curing one-component systems. The composition to be foamed is generally contained in disposable pressurised containers. These polyurethane foams are primarily used in the construction sector for sealing, insulating and installing e.g. joints, roofs, windows and doors. However, the NCO-terminated polyurethane prepolymers according to the invention can also be used in PU foam materials, for example as rigid PU foam for articles.

Another preferred application uses the polyurethane compositions according to the invention as a component of kneadable moulding compositions or encapsulating compounds. These are, for example, curable liquid or pasty materials which can also be used in the foodstuffs sector or in the medical sector. In this case it should be ensured that any additional auxiliary substances and additives that may be needed do not have any properties that present a health risk, and in particular they should have the appropriate licence for use in medicinal products. Examples of these materials are encapsulating compounds for the bonding of dialysis filters, encapsulating compounds for the bonding of filters for liquid foodstuffs, kneadable moulding compositions for use as a plaster of Paris substitute in medical technology or similar uses. The compositions in principle of these materials are known, but the reactive PU compositions that can be used according to the invention lead to products which substantially contain no polyamines and/or monomeric aromatic diisocyanates that are capable of migrating or that present a health risk.

The compositions according to the invention are particularly suitable in uses which can cause a risk to humans. Examples of these are adhesively bonded articles such as films, labels and packages which can come into contact with foodstuffs. Other examples are articles in the medical sector, e.g. adhesive dressings, filters, medical support material, such as plaster of Paris substitute, and similar products. Articles made of PU materials which are in frequent contact with humans are also affected, such as e.g. clothing, shoes, furniture surfaces or surfaces of add-on parts in motor vehicles.

After crosslinking, the articles and products made from the 1-component or 2-component PU compositions according to the invention do not contain any components capable of migration originating from the isocyanates or their precursors. Even in later processing steps, such as sterilisation, heating through the contents or storage in a moist atmosphere, even in the long term no aromatic polyamines capable of migration are formed, or only very small quantities which are not critical on the basis of current knowledge.

The reactive isocyanate reaction products or PU prepolymers which are suitable according to the invention and the polyurethane compositions produced therefrom are used in particular in reactive adhesives/sealants, encapsulating compounds and in flexible, rigid and integral foams. They are used for example in one-component or two-component form. Products are obtained with a good crosslinking reaction and good mechanical properties, without the additional need to use oligomeric or monomeric isocyanates containing NCO groups. One advantage over the known reactive one- and two-component adhesives/sealants, bonding foams, encapsulating compounds and flexible, rigid and integral foams is the significantly lower proportion of monomeric diisocyanates which are capable of migration and are harmful from an occupational health point of view and/or the hydrolysis products thereof. Another advantage over known, low monomer content reactive polyurethanes lies in the significantly reduced viscosity of the compositions according to the invention.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

The present invention is explained below by means of examples.

### EXAMPLES

Desmophen® 1262 BD, Desmophen® 1111 BD and Desmophen® VPPU 28HS98 are polyethers from Bayer MaterialScience AG.

Desmodur® 2460 M, Desmodur® VKS 20 and Desmodur® VK5 are monomeric and polymeric MDI from Bayer MaterialScience AG.

### Example 1 (Comparative Test)

702.67 g Desmodur® 2460 M are taken at 80° C. and 297.33 g of a dewatered mixture of 6.4 wt. % Desmophen® 1262 BD, 18.6 wt. % Desmophen® 1111 BD and 75.0 wt. % g Desmophen® VPPU 28HS98 are metered into the isocyanate and kept at 80° C. while stirring until a constant NCO content is reached. The product is then distilled at 180° C. and 0.03 mbar using a short-path evaporator. A product is obtained with an NCO content of 6.9 wt. %, a free diisocyanate content of 0.18 wt. %, a viscosity of 350 200 mPas at 50° C. and a calculated functionality of 3.

### Example 2 (According to the Invention)

629.07 g Desmodur® VK5 are taken at 80° C. and 370.93 g of a dewatered mixture of 25.65 wt. % Desmophen® 1262 BD and 74.35 wt. % Desmophen® 1111 BD are metered into the isocyanate and kept at 80° C. while stirring until a constant NCO content is reached. The product is then distilled at 180° C. and 0.03 mbar using a short-path evaporator. A product is obtained with an NCO content of 6.4 wt. %, a free diisocyanate content of 0.18 wt. %, a viscosity of 25 000 mPas at 50° C. and a calculated functionality of 3.

### Example 3 (According to the Invention)

1599.70 g Desmodur® VK20 are taken at 80° C. and 900.30 g of a dewatered mixture of 25.65 wt. % Desmophen® 1262 BD and 74.35 wt. % Desmophen® 1111 BD are metered into the isocyanate and kept at 80° C. while stirring until a constant NCO content is reached. The product is then distilled at 180° C. and 0.03 mbar using a short-path evaporator. A product is obtained with an NCO content of 11.81 wt. %, a free diisocyanate content of 0.44 wt. %, a viscosity of 85 900 mPas at 50° C. and a calculated functionality of 4.81.

### Example 4 (Comparative Test)

Desmodur® VKS 20 is demonomerised in an evaporator cascade consisting of a preliminary evaporator and a main evaporator (short-path evaporator) at 195° C. and 0.16-0.44 mbar in the preliminary evaporator and 180° C. and 0.20-0.35 mbar in the short-path evaporator. A product is obtained with an NCO content of 28.50 wt. %, a free diisocyanate content of 1.30 wt. %, a viscosity of 4 840 mPas at 50° C. and a calculated functionality of 3.55.

611.22 g demonomerised Desmodur® VKS 20 are taken at 80° C. and 388.78 g of a dewatered mixture of 25.64 wt. % Desmophen® 1262 BD and 74.36 wt. % Desmophen® 1111 BD are metered into the isocyanate and kept at 80° C. while stirring until a constant NCO content is reached. A product is obtained with an NCO content of 12.71 wt. %, a free diisocyanate content of 0.4 wt. %, a viscosity of 896 000 mPas at 50° C. and a calculated functionality of 4.80.

The NCO content is determined in accordance with DIN EN 1242.

The viscosity determination takes place using the MCR 301 rheometer from Anton-Paar. The Z4 and CC27 spindle/measuring cup system was used. The viscosity was recorded as a function of shear rate and evaluated using the Carreau-Yasuda algorithm.

1. A crosslinking 1-component or 2-component polyurethane composition comprising an NCO-terminated polyurethane prepolymer, wherein said NCO-terminated polyurethane prepolymer is (1) the reaction product of a polyol and an aromatic polymeric isocyanate having an average functionality of greater than 2, (2) contains at least two NCO groups, and (3) has a content of unreacted monomeric isocyanates of less than 5 weight %.

2. The composition of claim 1, wherein said prepolymer has a content of unreacted monomeric aromatic isocyanates of less than 3 weight %.

3. The composition of claim 1, wherein said prepolymer has a content of unreacted monomeric aromatic isocyanates of less than 1 weight %.

4. The composition of claim 1, wherein said prepolymer has a content of unreacted monomeric aromatic isocyanates of less than 0.2 weight %.

5. The composition of claim 1, wherein said aromatic polymeric isocyanate comprises a proportion of a monomeric isocyanate of at least 10 weight %.

6. The composition of claim 1, wherein said prepolymer further comprises a low monomer content polymeric aromatic isocyanate having a functionality of greater than 2.

7. A reactive polyurethane prepolymer prepared from the composition of claim 1.

8. A crosslinking component in a crosslinkable 1-component or 2-component polyurethane composition, wherein said crosslinking component comprises the composition of claim 1.

9. A reactive 1-component or 2-component adhesive or sealant comprising the composition of claim 1.

10. A laminating adhesive or hot-melt adhesive comprising the composition of claim 1.

11. A bonding, flexible, rigid, or integral foam comprising the composition of claim 1.

12. A moisture-curing plastic moulding composition or encapsulating compound comprising the composition of claim 1.
